(19) United States
(12) Patent Application Publication
(10) Pub. No.: US 2001/0002569 A1
(43) Pub. Date: Jun. 7, 2001

(54) APPARATUS FOR CUTTING ADHESIVE TAPE MOUNTED ON SEMICONDUCTOR WAFER

(76) Inventors: SUNG HO LEE, CHUNGCHEONGNAM-DO (KR); YOUN CHOUL LEE, CHUNGCHEONGNAM-DO (KR); SUNG BOK HONG, CHUNGCHEONGNAM-DO (KR); KYOUNG BOK CHO, CHUNGCHEONGNAM-DO (KR)

Correspondence Address: DAVID T MILLERS, SKJERVEN MORRILL MACPHERSON, FRANKLIN & FRIEL, 25 METRO DRIVE SUITE 700, SAN JOSE, CA, 951101349

(21) Appl. No.: 09/225,196

(22) Filed: Jan. 5, 1999

(30) Foreign Application Priority Data
Jan. 17, 1998 (KR) 1998-1316

(51) Int. Cl. B26D 3/08

(52) U.S. Cl. 83/873; 83/13

(57) ABSTRACT

An apparatus for cutting an adhesive tape attached to a semiconductor wafer and a wafer ring is disclosed. The apparatus includes cutters and rollers. In cutting the adhesive tape, the cutters are aligned on the wafer ring which contains the semiconductor wafer within the wafer ring. The cutters move rolling in a circle along the wafer ring by a rotation of a rotating body, and cut the adhesive tape into two portions. The rollers follow the cutters pressing the inside portion of the tape to secure the adhesion between the adhesive tape and the wafer ring. The apparatus may further include a stationary sensor and marks on the rotating body to control the rotation of the rotating body.

### BACKGROUND OF THE INVENTION

1. Field of the Invention

The present invention relates to electronic packaging and assembly technology and to an apparatus for cutting an adhesive tape to which a semiconductor wafer and a wafer ring are attached.

2. Description of the Prior Art

In manufacturing semiconductor devices, wafer fabrication processes form a wafer that includes multiple integrated circuits, and assembly or packaging processes typically begin by sawing the wafer to separate individual integrated circuit chips. For a typical sawing process, an adhesive tape 20, as shown in FIG. 1, fixes a semiconductor wafer 24 to a wafer ring 26 to prevent wafer 24 from moving or breaking away during the sawing. Attaching adhesive tape 20 to wafer 24 and wafer ring 26 is often referred to as a tape mounting process.

FIGS. 2 and 3 schematically show a conventional tape mounting process. As depicted in FIG. 2, wafer 24 is placed on a table 10 having a chuck which is not shown but widely known in the art, and wafer ring 26 is placed on table 10 with wafer 24 in wafer ring 26. Wafer 24 typically has a diameter of about 6˜12 inches, and wafer ring 26 has a diameter somewhat greater than that of wafer 24. Adhesive tape 20 is places on wafer 24 and wafer ring 26, and a roller 16 moves horizontally, applying pressure to the upper surface of tape 20, so that tape 20 attaches to wafer 24 and wafer ring 26. Finally, a cutter cuts tape 20 along the edges of wafer ring 26.

As shown in FIG. 3, to cut tape 20, a rotating shaft 14 presses a cutter 12, which is at an end of rotating shaft 14, into tape 20 as cutter 12 rolls along the edge of wafer ring 26. As a result, tape 20 separates into two portions, namely, an inside portion 20a and an outside portion 20b. Inside portion 20a of tape 20 remains attached to wafer ring 26 and wafer 24 when a take-up roll 18 shown in FIG. 4 removes outside portion 20b from wafer ring 26. As illustrated in FIG. 4, take-up roll 18 moves horizontally in the opposite direction of roller 16 of FIG. 2, winding up outside portion 20b of tape 20. The tape cutting method shown in FIG. 3 often causes inside portion 20a of tape 20 to peel away from wafer ring 26 at an edge A of inside portion 20a. Such peeling-off often create further peeling-off of tape 20 during handling of tape-mounted wafer 24, or winding-up of inside portion 20a during removing outside portion 20b.

### SUMMARY OF THE INVENTION

An apparatus for cutting an adhesive tape, which is attached to a semiconductor wafer and a wafer ring, is disclosed. Further, an adhesive tape cutting method using the apparatus is also disclosed. The apparatus and method can prevent the adhesive tape from undesirably peeling off the wafer ring.

In accordance with an embodiment of the present invention, an apparatus for cutting an adhesive tape after a tape mounting process includes a table where a semiconductor wafer is placed, a rotating body driven by a first rotating shaft, two cutters connected with the rotating body by two connecting arm, each of which includes a second rotating shaft, and two rollers which are paired with respective cutters and connected to the connecting arms. In the operation of the apparatus, after the tape mounting process, the cutters are aligned on the wafer ring. Then, the rotating body rotates and makes the connecting arms move in along the edge wafer ring. In accordance with the movement of the connecting arm, the cutters roll on the wafer ring and cut the adhesive tape, and the rollers, which move behind the cutters, press the adhesive tape to secure the adhesion between the tape and the wafer ring. The second rotating shafts are geared perpendicularly to the first rotating shaft and drive the cutters to rotate.

In another embodiment of the present invention, the connecting arms connect to the rotating body at a uniform angular interval, and the rotating body rotates as much as the interval angle. In order to facilitate the rotating body to rotate only the interval angle, the apparatus may further include a number of marks on the periphery of the rotating body and a stationary sensor above the rotating body. After the sensor detects a first mark, the rotating body begins to move. When the sensor detects a second mark, the rotating body stops.

### BRIEF DESCRIPTION OF THE DRAWINGS

FIG. 1 is a perspective view of a semiconductor wafer and a wafer ring affixed to adhesive tape.

FIG. 2 illustrates a conventional tape mounting process.

FIG. 3 is a partial perspective view illustrating a conventional tape cutting operation.

FIG. 4 is a schematic view illustrating a conventional tape removing process.

FIG. 5 is a front view of an adhesive tape cutting apparatus in accordance with an embodiment of the present invention.

FIG. 6 is a top view of the adhesive tape cutting apparatus of FIG. 5.

FIG. 7 is a partial perspective view illustrating the tape cutting operation of the apparatus of FIG. 5.

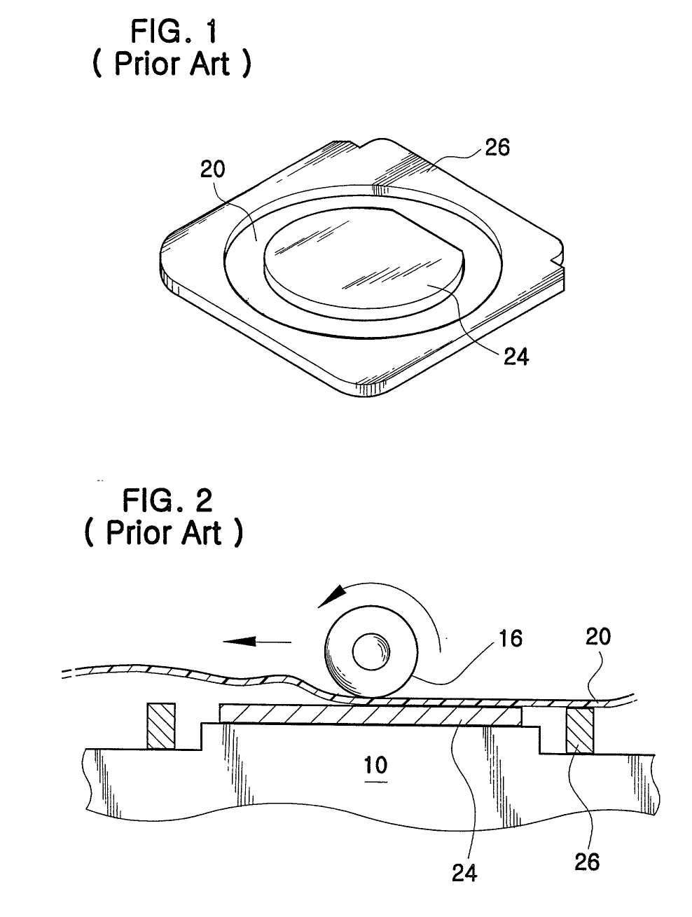

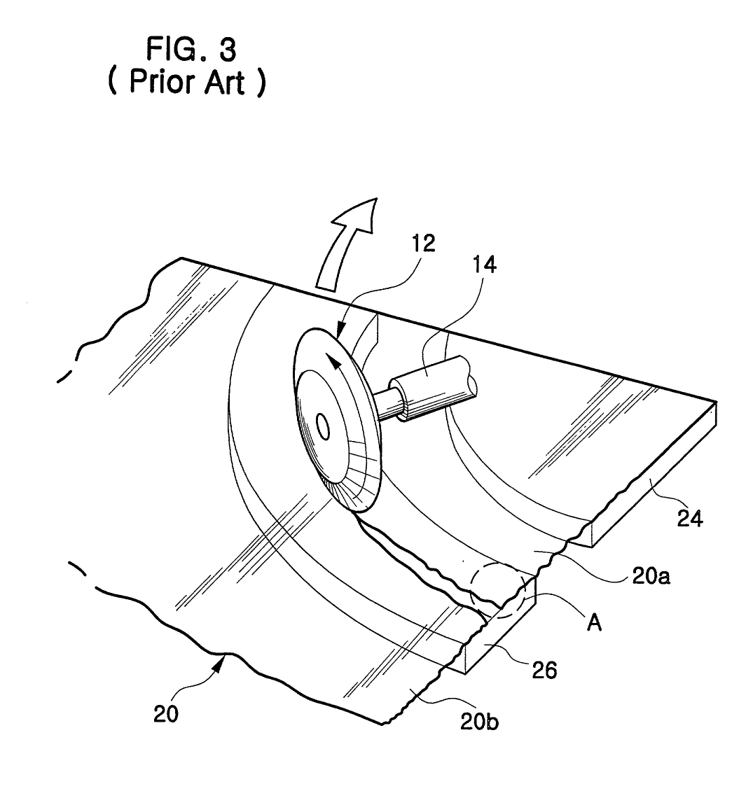

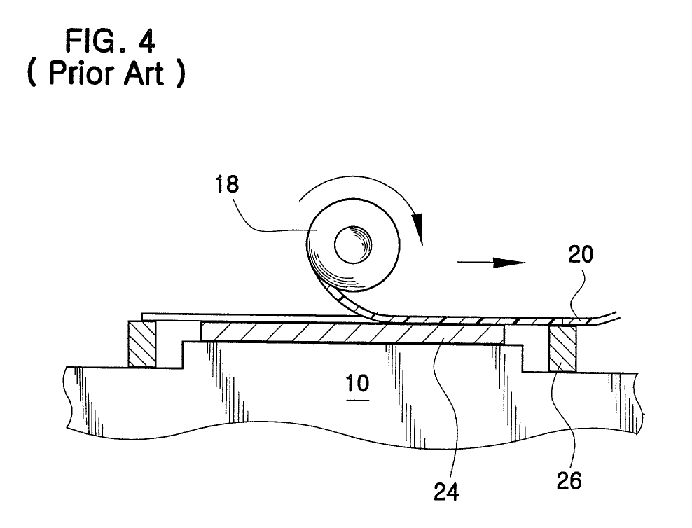

### DETAILED DESCRIPTION OF THE PRESENT INVENTION

The present invention will now be described more fully hereinafter with reference to accompanying drawings, in which preferred embodiments of the invention are shown. This invention may, however, be embodied in many different forms and should not be construed as limited to the embodiments set forth herein. In the drawings, like numbers refer to like elements.

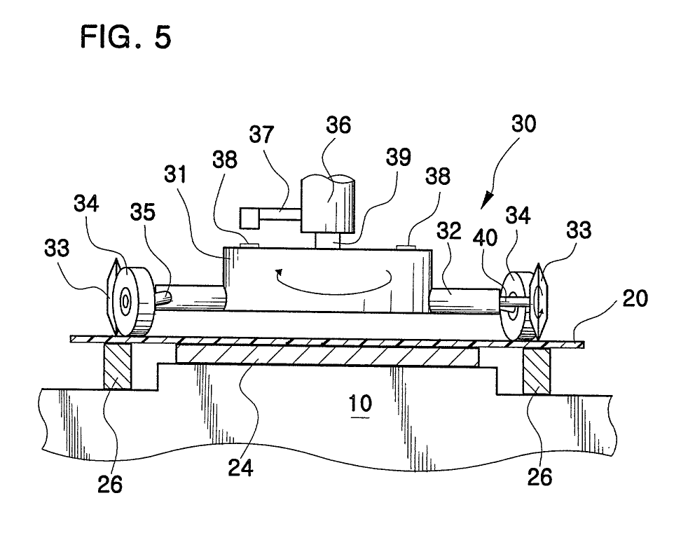

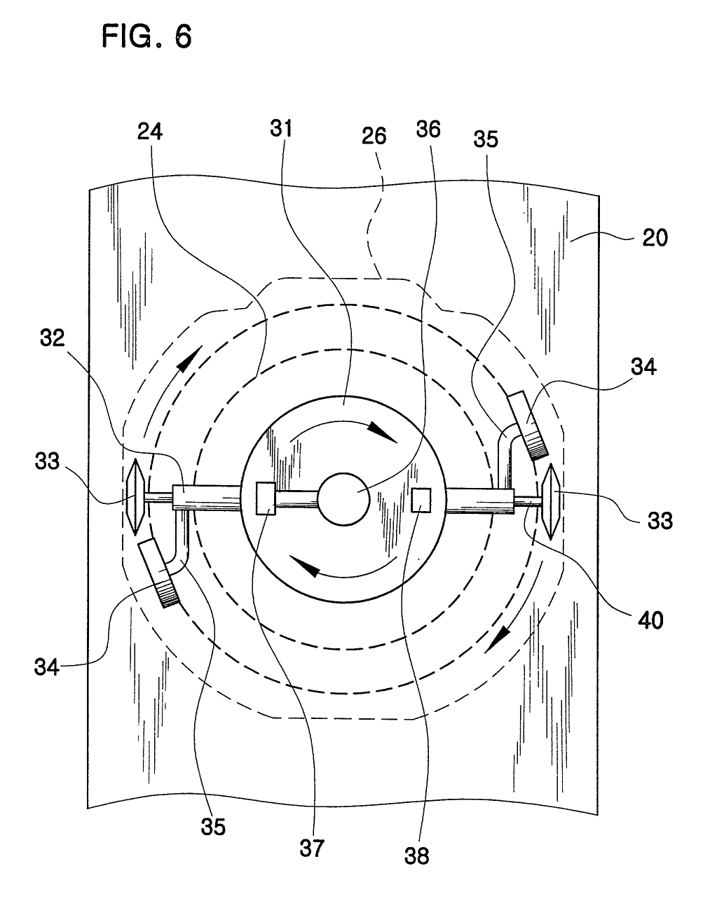

FIGS. 5 and 6 are respectively front and side view of one embodiment of an adhesive tape cutting apparatus 30 according to the present invention. Apparatus 30 includes a table 10, a rotating body 31, two cutters 33, and two rollers 34. As described above, a semiconductor wafer 24 which includes a number of semiconductor integrated circuits, is fixed to a wafer ring 26 by an adhesive tape 20 to prevent wafer 24 from moving or breaking away during a sawing process. After a tape mounting process, which was described above, the part of adhesive tape 20 beyond the perimeter of wafer ring 26 needs to be removed.

To cut adhesive tape 20 for removal of the unwanted part, rotating body 31 is positioned above table 10, and a vertical rotating shaft 39, which is connected to rotating body 31 and driven by a motor (not shown), rotates rotating body 31. Two cutters 33 are connected to rotating body 31 by connecting arms 32. Connecting arms 32 horizontally extend outward from rotating body 31, so that cutters 33 are above wafer ring 26. After rotating body 31 is lowered so that cutters 33 are on wafer ring 26 and pressing into adhesive tape 20, cutters 33 move in a circle rolling on wafer ring 26 as rotating body 31 rotates. The pressure and movement of cutters 33 cuts adhesive tape 20 to separate an inside portion 20a from an outside portion 20b.

Although this embodiment includes two cutters 33 disposed at a 180° angle, more than two cutters can be employed with a uniform angular interval. For example, three cutters at 120° intervals may be employed. Rotating body 31 of the invention needs to rotate only as much as the angle between two adjacent cutters, while the rotating bodies that have only one cutter must rotate around a full circle. Accordingly, the use of multiple cutters can reduce the time required for a cutting operation.

Referring to FIG. 5, each cutter 33 rotates on a horizontal rotating shaft 40 included in connecting arm 32. Horizontal rotating shaft 40 is geared perpendicularly into vertical rotating shaft 39 which drives rotating body 31. A coupling member such as a worm gear or a bevel gear which is well known in the art is used for jointing two shafts 39 and 40, however other devices can be used as alternatives.

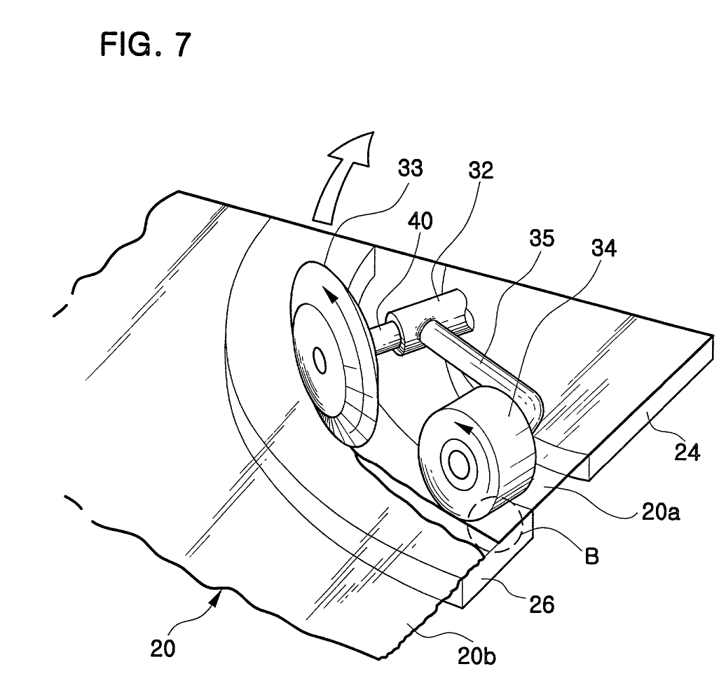

A tape cutting apparatus according to the present invention further includes rollers 34. As illustrated in FIG. 7, each roller 34 is connected to a connecting arm 32 by a coupling rod 35 and is coupled with a cutter 33 so that roller 34 follows cutter 33 when cutter 33 rolls and cuts adhesive tape 20. Roller 34 is on inside portion 20a of tape 20 so that the outer edge of roller 34 moves along the tape cutting line. Roller 34 freely rotates on coupling rod 35 and applies a slight pressure on the edge of inside portion 20a to affix any peeling off portion of adhesive tape 20a, as shown in FIG. 7. A reference letter ‘B’ in FIG. 7 shows an area where tape 20 is completely attached to wafer ring 26 without peeling off. In addition, it is preferable that the surfaces of rollers 34 are made of an elastic material such as rubber, silicone, or the like.

Referring to FIGS. 5 and 6 again, in order to facilitate rotation of rotating body 31 through only the interval angle described above, apparatus 30 may further include a number of marks on the periphery of rotating body 31 and a stationary sensor 37 located above rotating body 31. Apparatus 30 having two cutters 33 may have two marks spaced 180 degrees apart. When an apparatus according to the invention includes three cutters, the angle between two adjacent marks is 120 degrees. Sensor 37 is above rotating body 31 and fixed to a stationary element 36 which partly covers rotating shaft 39 but does not rotates. Sensor 37 detects marks 38 on the periphery of rotating body 31. Sensor 37 and rotating body 31 are connected with a control system that controls the rotation of rotating body 31. After sensor 37 detects first mark 38, rotating body 31 begins to move. The control system stops rotating body 31 when sensor 37 detects second mark 38. For more reliable cutting operations, rotating body can rotate through slightly more than the angle between two adjacent cutters 33 or marks 38.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. An apparatus for cutting an adhesive tape which is attached to a semiconductor wafer and a wafer ring, the apparatus comprising:
a table on which the semiconductor wafer held within the wafer ring by the adhesive tape is placed and fixed;
a rotating body located above the table and driven by a first rotating shaft;
a cutter connected with the rotating body by a connecting arm, wherein the cutter moves in a circle by the rotation of the rotating body; and
a roller which is paired with the cutter so that the roller follows the cutter when the cutter moves forward.

2. The apparatus of claim 1, wherein the surface of the roller is made of an elastic material.

3. The apparatus of claim 1, wherein the connecting arms includes a second rotating shaft therein so that the cutter rotates on the second rotating shaft, wherein the second rotating shaft is geared perpendicularly into the first rotating shaft.

4. The apparatus of claim 1, further comprising one or more additional cutters and rollers, wherein the cutters are spaced at a uniform angular interval

5. The apparatus of claim 4, wherein the rotating body rotates as much as the angular interval and less than a full circle to complete a cutting process.

6. The apparatus of claim 4, further comprising:
a stationary sensor located above the rotating body; and
marks on the periphery of the rotating body, wherein the rotating body begins to rotate for a cutting process when the sensor detects one of the marks and stops rotating when the sensor detects another mark.

7. A method for cutting an adhesive tape which is attached to a semiconductor wafer and a wafer ring, the method comprising:
placing the wafer ring on a table, the adhesive tape being on the wafer ring;
aligning a cutter on the wafer ring;
moving the cutter along the wafer ring to cut the adhesive tape attached to the wafer ring into an inside tape portion and an outside tape portion; and
pressing the inner tape portion to secure the attachment of the adhesive tape to the wafer ring.

8. The method of claim 7, wherein a roller that is paired with the cutter follows the cutter to press the inside tape portion.

9. The method of claim 7, wherein two or more cutters are aligned on the wafer ring at a uniform angular interval.

10. The method of claim 9, wherein each of the cutters moves on the wafer ring at the angular interval.

11. The method of claim 9, wherein each of the cutters simultaneously moves on the wafer ring slightly more than the angular interval.
